(19) United States
(12) Patent Application Publication
(10) Pub. No.: US 2026/0326027 A1
(43) Pub. Date: Oct. 22, 2026

(54) A METHOD AND SYSTEM FOR REMOVING CO2 FROM A GAS

(71) Applicant: GREENCAP SOLUTIONS AS, SANDNES (NO)

(72) Inventor: Tor CHRISTENSEN, Sandefjord (NO)

(21) Appl. No.: 19/116,761

(22) PCT Filed: Aug. 31, 2023
(86) PCT No.: PCT/NO2023/060041

§ 371 Date: Mar. 28, 2025

(30) Foreign Application Priority Data
Sep. 30, 2022 (NO) 20221044

(51) Int. Cl. B01D 53/26; B01D 46/00; B01D 51/10; B01D 53/04; B01D 53/06

(52) U.S. Cl. CPC B01D 53/261; B01D 46/0036; B01D 51/10; B01D 53/0438; B01D 53/06; B01D 2253/108; B01D 2257/504; B01D 2257/80

(57) ABSTRACT

A method, and a system, for removing CO₂ from a gas include conducting the gas through an enthalpy wheel, including a storage mass coated with an H₂O adsorbent, thereby adsorbing moisture and absorbing heat from the gas, the temperature efficiency, η_{T}, of the enthalpy wheel being at least 70%, cooling the gas from the enthalpy wheel by a first heat exchanger, further cooling the gas from the first heat exchanger by a chiller, adsorbing CO₂ from the gas from the chiller by a zeolite adsorption bed, heating the gas from the zeolite adsorption bed in the first heat exchanger, thereby providing the cooling the gas from the enthalpy wheel, and conducting the gas from the first heat exchanger through the enthalpy wheel, thereby releasing from the enthalpy wheel the adsorbed moisture adsorbed and the absorbed heat.

### FIELD OF DISCLOSURE

The present disclosure relates to the field of CO₂ capture and storage.

### BACKGROUND

The field of carbon capture and storage, CCS, has experienced a rapid growth since the turn of the last millennium. CCS is increasingly being considered for a wide range of gaseous CO₂ sources, including sources with extremely low concentrations such as ambient air, sources with higher concentrations such as air from vegetable storage spaces, and sources with relatively high concentrations such as flue gas from combustion processes. The direct capture of CO₂ from air, or Direct Air Capture, DAC, has recently gained significant interest as a means to limit climate change. DAC facilities could provide negative emissions or could be assigned to positive emissions to annul these.

One known approach for how to remove CO₂ from a gas is through CO₂ adsorption using zeolites. Absorption of CO₂ may here be performed by running a CO₂-containing gas through a zeolite until the zeolite gets saturated. The CO₂ may subsequently be recovered from the zeolite by heating the zeolite and thereby causing the adsorbed CO₂ to be desorbed. Any desorbed CO₂ may subsequently be conducted to a tank or to an external system for utilization. After recovery, an adsorption process may again be initiated, where CO₂-containing gas once again is conducted through the zeolite for adsorption. The process of adsorbing and desorbing CO₂ will herein be referred to as an adsorption and desorption cycle.

Zeolites are three-dimensional, microporous, crystalline solids with well-defined structures that may interchange water and carbon dioxide molecules in their structural pores. Water may move freely in and out of the pores in the crystalline structure, while the zeolite framework remains rigid. One particular aspect of the rigid structure of zeolites is that the pore and channel sizes are nearly uniform, allowing the crystal to act as a molecular sieve. WO2018/034570 describes a unit for capturing CO₂ from ambient air, where a zeolite has been employed as an adsorbent.

There are two main issues with the use of zeolites for CO₂ capture. The first is the need to alternately cool and heat the zeolite during CO₂ adsorption and desorption cycling. The temperature difference in the zeolite during adsorption and desorption may for some zeolites be as high as 300 °C, and the heating and cooling requirements during long time use may therefore be extensive.

The second issue with the use of zeolites for CO₂ capture is the very strong zeolite affinity for H₂O. Any trace of moisture in the gas containing CO₂ will be adsorbed quickly and preferentially at the zeolite inlet. However, CO₂ may still be effectively adsorbed, for example though employment of a deep zeolite bed, as much of the zeolite further into the bed will remain dry as long as the amount of moisture supplied with the CO₂-containing gas is insufficient to saturate more than the zeolite inlet. Water must in any case eventually be removed from the zeolite, for example after an adsorption run, or the zeolite will eventually be saturated with moisture throughout and therefore become unable to capture CO₂. Such removal of water from zeolite is very energy intensive.

It is an aim of the present disclosure to provide a system and method for removing CO₂ from a gas that addresses some of the issues described above.

### SUMMARY OF THE DISCLOSURE

A first aspect of the present disclosure provides a method for removing CO₂ from a gas, the method comprising the steps of a) conducting the gas through an enthalpy wheel comprising a storage mass coated with an H₂O adsorbent, thereby adsorbing moisture and absorbing heat from the gas, wherein the temperature efficiency, η_{T}, of the enthalpy wheel is at least 70%. b) cooling the gas from the enthalpy wheel by a first heat exchanger, c) further cooling the gas from the first heat exchanger by a chiller, d) adsorbing CO₂ from the gas from the chiller by a zeolite adsorption bed, e) heating the gas from the zeolite adsorption bed in the first heat exchanger, thereby providing the cooling in step b), and f) conducting the gas from the first heat exchanger through the enthalpy wheel, thereby releasing from the enthalpy wheel, moisture adsorbed and heat absorbed in step a).

In an embodiment of the disclosure, the method further comprises the step e2), between step e) and step f) of further heating the gas from the first heat exchanger using heat generated by the chiller.

In another embodiment of the disclosure, the pressure difference between the gas entering and exiting the enthalpy wheel in step a) is in the range 30-100 Pa, preferably in the range 40-80 Pa, and more preferably in the range 45-55 Pa.

In yet another embodiment of the disclosure, the velocity of the gas conducted through the enthalpy wheel in step a) is in the range 1-2 m/s.

In yet another embodiment of the disclosure, the dew point of the gas exiting the enthalpy wheel in step a) is no higher than −25 °C.

In yet another embodiment of the disclosure, the dew point of the gas exiting the enthalpy wheel in step a) is at least −35 °C.

In yet another embodiment of the disclosure, the temperature difference between the gas entering and exiting the heat exchanger in step c) is in the range 2-15 °C.

In yet another embodiment of the disclosure, the temperature difference between the gas entering and exiting the chiller in step d) is in the range 1-4 °C.

In yet another embodiment of the disclosure, the dew point of the gas exiting the zeolite adsorption bed in step d) is no higher than −60 °C.

In yet another embodiment of the disclosure, the method comprises an initial step prior to step a) of removing at least 50% of all solid particulates with a diameter exceeding 1 micron.

A second aspect of the present disclosure provides a system for removing carbon dioxide from a gas, the system comprising: a gas inlet for receiving the gas, an enthalpy wheel comprising a supply segment, an extract segment, and a storage mass coated with an H₂O adsorbent, a first heat exchanger comprising a first heat exchanger first conduit and a first heat exchanger second conduit, a chiller comprising a second heat exchanger, wherein the second heat exchanger comprises a second heat exchanger first conduit and a second heat exchanger second conduit, and wherein the chiller is configured to circulate cooling fluid through the second heat exchanger second conduit, a zeolite adsorption bed, and a gas outlet, wherein the gas inlet is in fluid communication with the zeolite adsorption bed via first the supply segment of the enthalpy wheel, followed by the first heat exchanger first conduit and then the second heat exchanger first conduit, wherein the zeolite adsorption bed is in fluid communication with the gas outlet via the first heat exchanger second conduit, and followed by the extract segment of the enthalpy wheel.

In an embodiment of the disclosure, the system further comprises a filter arranged between the gas inlet and the supply segment of the enthalpy wheel, the filter being configured to remove from the gas at least 50% of all solid particulates with a diameter exceeding 1 micron.

In another embodiment of the disclosure, the system further comprises a third heat exchanger comprising a third heat exchanger first conduit and a third heat exchanger second conduit, wherein the chiller is configured to dissipate heat via the third heat exchanger first conduit and wherein the third heat exchanger second conduit is connected in series with and between the first heat exchanger second conduit and the extract segment of the enthalpy wheel.

In yet another embodiment of the disclosure, the system further comprises at least one fan positioned between the chiller and the zeolite adsorption bed and/or between the first heat exchanger second conduit and the extract segment of the enthalpy wheel.

In yet another embodiment of the disclosure, the storage mass is an aluminium mesh and/or where the H₂O adsorbent is a 3A molecular sieve or silica gel.

### BRIEF DESCRIPTION OF THE DRAWINGS

FIG. 1 is a schematic illustration of a system for removing carbon dioxide from a gas,

FIG. 2 is a schematic illustration of a system for removing carbon dioxide from a gas, where the chiller comprises a heat pump and a heat exchanger,

FIG. 3 is a schematic illustration of a system for removing carbon dioxide from a gas, where the system comprises at least one fan for driving the gas through the system,

FIG. 4 is a schematic illustration of a system for removing carbon dioxide from a gas, where the system comprises a plurality of enthalpy wheel connected in a series,

FIG. 5a is a schematic illustration of an enthalpy wheel according to the present disclosure visualized without any cover,

FIG. 5b is a schematic illustration of an enthalpy wheel according to the present disclosure visualized from a first side with a cover,

FIG. 5c is a schematic illustration of an enthalpy wheel according to the present disclosure visualized from a second side with a cover, and

FIG. 6 is a schematic illustration of an enthalpy wheel according to the present disclosure comprising a supply segment inlet and outlet and an extract segment inlet and outlet.

### DETAILED DESCRIPTION OF THE DISCLOSURE

In the following, general embodiments as well as particular exemplary embodiments of the disclosure will be described. References will be made to the accompanying drawings. It shall be noted, however, that the drawings are exemplary embodiments only, and that other features and embodiments may well be within the scope of the disclosure as claimed. Further, the mentioning of references such as “a” or “an” etc. should not be construed as excluding a plurality, and the term “disclosure” may herein be used interchangeably with the term “invention”.

Unless otherwise defined, all terms of art, notations and other scientific terms or terminology used herein are intended to have the meanings commonly understood by those of skill in the art to which this disclosure pertains. Certain terms of art, notations, and other scientific terms or terminology may, however, be defined specifically as indicated below.

The present disclosure provides a method and system for removing CO₂ from a gas. The method and system relate more specifically to the use of a zeolite adsorption bed as absorbent for removing CO₂ from a gas. It will be appreciated by a person skilled in the art that the system described herein may be employed in order to execute the method.

The system and method according to the present disclosure may generally be employed to perform an adsorption cycle of a CCS process. A separate system and method, not described herein, may be used to recover the zeolite adsorption bed. The system or method according to the present disclosure may thus be combined with other systems or methods in order to provide a full CCS adsorption and recovery cycle.

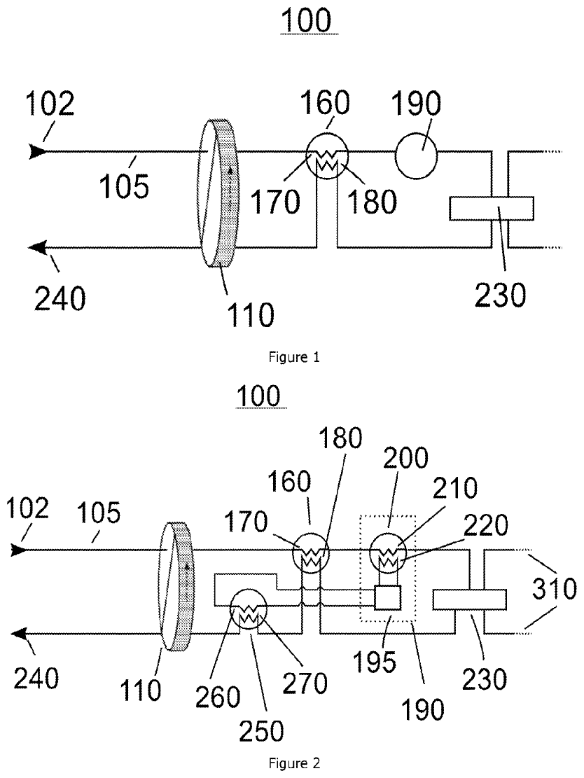

Referring to FIG. 1, the system for removing CO₂ from a gas may according to the present disclosure comprise a gas inlet 102, an enthalpy wheel 110, a first heat exchanger 160, a chiller 190 and a zeolite adsorption bed 230. As will be appreciated by a person skilled in the art with knowledge of the present disclosure, the system 100 may further comprise any one or more of a gas outlet 240, one or more valves, one or more pipe segments 105, one or more connectors etc. necessary for functionally connecting the system together. The gas inlet 102, enthalpy wheel 110, first heat exchanger 160, chiller 190 and zeolite adsorption bed 230 may here be connected in series and may be considered as being in fluid communication with each other. The latter can be understood to mean that a fluid may flow from one component to another, for example though interconnecting conduits.

Still with reference to FIG. 1, gas entering the system 100 though the gas inlet 102 may flow downstream toward the zeolite adsorption bed 230, i.e. first through the enthalpy wheel 110, then through the first heat exchanger 160, then thought the chiller 190, before finally reaching the zeolite adsorption bed 230. Gas flowing out of the zeolite adsorption bed 230 may flow further downstream from the zeolite adsorption bed 230, through the first heat exchanger 160, then through the enthalpy wheel 110 and then for example out through a gas outlet 240, or alternatively into another system (not shown).

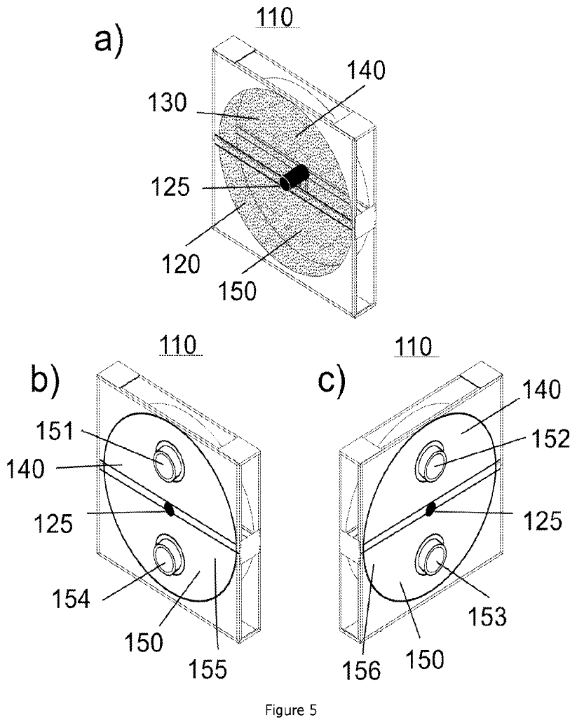

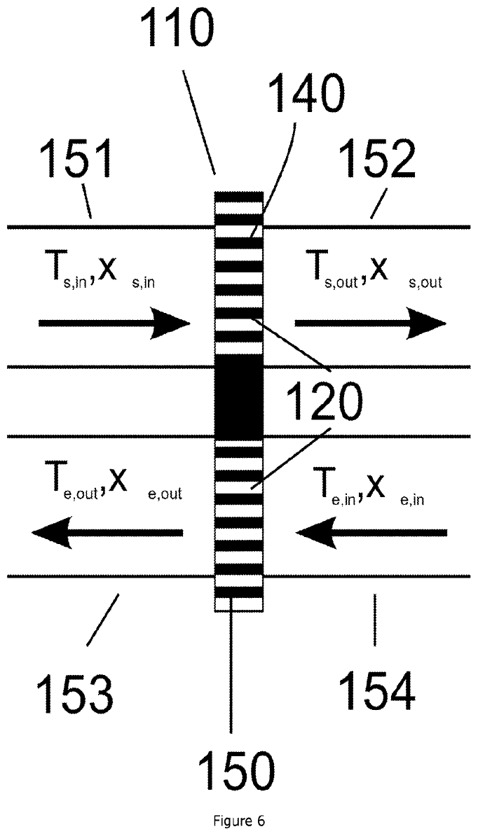

An enthalpy wheel 110 may as schematically illustrated in FIGS. 5a, 5b and 5c comprise a storage mass 120 coated with an H₂O adsorbent 130. The enthalpy wheel 110 may thus be configured to absorb heat in addition to being configured to adsorb moisture. An enthalpy wheel 110 may generally comprise at least two segments, a supply segment 140 and an extract segment 150. The supply segment 140 may be coupled with a supply segment inlet 151 and a supply segment outlet 152 for connecting the supply segment 140 with for example a gas conduit, or a gas flow line. Likewise, the extract segment 150 may be coupled with an extract segment inlet 153 and an extract segment outlet 154 for connecting the extract segment 150 with for example a gas conduit, or a gas flow line. The storage mass 120 may be configured to rotate, e.g. around a rotor axis 125, such that any segment of the storage mass 120 moves between the supply segment 140 and the extract segment 150 of the enthalpy wheel 110. Said rotation of the storage mass 120 allows for gas flowing through the supply segment 140 to give of moisture and heat to the storage mass 120 in the supply segment 140, and for gas flowing through the extract segment 150 to take up said moisture and heat from the storage mass 120 in the extract segment 150. The storage mass 120 may thus be gas permeable or comprise gas flow paths that allow gas to flow through. The storage mass may thus comprise a porous medium, a matrix or similar. FIG. 5a schematically illustrates an enthalpy wheel 110 comprising a storage mass 120 rotatable around a rotor axis 125. FIG. 5b schematically illustrates an enthalpy wheel 110 where the a storage mass 120 is located behind a closed front side cover 155, and where the front side cover 155 is provided with a supply segment inlet 151 and an extract segment outlet 154. FIG. 5c schematically illustrates an enthalpy wheel 110 visualized from the opposite side relative to FIG. 5b, where the a storage mass 120 is located behind a closed back side cover 156, and where the back side cover 156 is provided with a supply segment outlet 152 and an extract segment inlet 153.

The gas inlet 102 may, as schematically illustrated in FIG. 1, be connected with the enthalpy wheel 110 such that gas from the gas inlet 102 may be conducted through the enthalpy wheel 110. The gas inlet 102 may more specifically be connected with the supply segment 140 of the enthalpy wheel 110, for example via a supply segment inlet 151. FIG. 5 schematically illustrates an enthalpy wheel 110 comprising inter alia a supply segment 140 and an extract segment 150 with inlets 151, 153 and outlets 152, 154. As the gas is conducted through the enthalpy wheel 110, the gas comes in contact with the storage mass 120 of the enthalpy wheel 110. Moisture from the gas is thus adsorbed in the H₂O adsorbent 130, while heat is absorbed in the storage mass 120. The presence of the storage mass 120 in addition to the H₂O adsorbent 130 causes at least part of the latent heat released by adsorption of moisture from the gas in H₂O adsorbent 130 to be absorbed in the storage mass 120 of the enthalpy wheel 110. The temperature difference between the gas entering and exiting the supply segment 140 of the enthalpy wheel 110 may thus be limited, as the heat storage capacity of the storage mass 120 may be chosen according to the amount of H₂O adsorbent. The enthalpy wheel 110 may in a particular embodiment of the present disclosure be configured to absorb between 2500 to 4200 kJ/kg H₂O adsorbed. The enthalpy wheel 110 may additionally or alternatively be configured such that the temperature difference between the gas entering and exiting the supply segment 140 of the enthalpy wheel 110 is lower than 2 °C or optionally at least lower than 5 °C.

With reference to FIG. 1, the enthalpy wheel 110 may further be connected to a first heat exchanger 160 that may comprise a first heat exchanger first conduit 170 and a first heat exchanger second conduit 180. The supply segment 140 of the enthalpy wheel 110 may be connected to the first heat exchanger first conduit 170 such that gas may flow from the supply segment 140 of the enthalpy wheel 110 into and through the first heat exchanger first conduit 170. The first heat exchanger 160 may be configured to transfer heat between a fluid flowing in the first heat exchanger first conduit 170 and a fluid flowing in the first heat exchanger second conduit 180. According to the present disclosure, the gas from the supply segment 140 of the enthalpy wheel 110 may in the first heat exchanger first conduit 170 be cooled by a gas flowing in the first heat exchanger second conduit 180. As will be described further below, the gas in the first heat exchanger second conduit 180 may here be supplied from the zeolite adsorption bed 230. The gas from the enthalpy wheel 110 may according to the present disclosure be cooled by up to 15 °C in the first heat exchanger 160, preferably in the range 5 -15 °C. The temperature difference between the gas entering and exiting the heat exchanger first conduit 170 may according to the present disclosure be up to 15 °C, preferably in the range 2-15 °C, more preferable 2-5 °C. The latter temperature range has been found to be favourable in terms of energy usage.

As schematically illustrated in FIG. 1, the first heat exchanger 160 is further connected to a chiller 190. The heat exchanger first conduit 170 may be connected to the chiller 190 such that the gas may further flow from the first heat exchanger first conduit 170 into and through the chiller 190.

The chiller 190 may as schematically illustrated in FIGS. 1 and 2 comprise a heat exchanger, referred to from hereon as a second heat exchanger 200. The second heat exchanger 200 may comprise a second heat exchanger first conduit 210 and a second heat exchanger second conduit 220 and may be configured to transfer heat between a fluid flowing in the second heat exchanger first conduit 210 and a fluid flowing in the second heat exchanger second conduit 220. As illustrated in FIG. 2, the gas from the first heat exchanger first conduit 170 may be conducted through the second heat exchanger first conduit 210, while a cooling fluid may be conducted through the second heat exchanger second conduit 220. The chiller 190 may thus be configured cool the gas flowing through the second heat exchanger first conduit 210 by circulating cooling fluid through the second heat exchanger second conduit 210, for example through employment of a compressor and optionally a fan. In a particular embodiment of the present disclosure the chiller 190 further comprises a heat pump 195 configured to circulate cooling fluid through the second heat exchanger second conduit 220. The resulting heat from the heat pump 195 may be dissipated to the surroundings or may be utilized for heating as will be described further below.

As schematically illustrated in FIGS. 1 and 2, the chiller 190 may according to the present disclosure further be connected to the zeolite adsorption 230 bed such that cooled gas from the chiller 190 may flow into and through the zeolite adsorption bed 230. In the embodiment where the chiller 190 comprises second heat exchanger 200, the second heat exchanger first conduit 210 is connected to the zeolite adsorption bed 230 such that gas may flow from the second heat exchanger first conduit 210 into and through the zeolite adsorption bed 230.

The presence of a chiller has been found to be preferable in order to maintain a constant temperature in the zeolite adsorption bed. As the adsorption of CO₂ is exothermic, the temperature of the zeolite adsorption bed would in absence of a chiller steadily rise throughout an adsorption cycle. The latter would result in an earlier saturation of the zeolite adsorption bed and thus a lower adsorption capacity for the zeolite adsorption bed. The chiller may be employed to maintain a stable temperature in the zeolite adsorption bed during an adsorption cycle, thus improving the adsorption capabilities of the zeolite adsorption bed. According to an embodiment of the present disclosure, the chiller is configured to cool the gas flowing through the chiller, e.g through the second heat exchanger first conduit, by up to 5 °C, more preferably by 1-4 °C. Said amount of cooling has been found to be preferable in order to obtain an energy efficient adsorption cycle.

As schematically illustrated in FIG. 1, the gas may after having cooled by the chiller 190, flow into the zeolite adsorption bed 230. The zeolite adsorption bed 230 may adsorb the CO₂ in the gas, as well as any remaining H₂O that was not adsorbed by the enthalpy wheel 110. The zeolite adsorption bed 230, may here be capable of dehydrating gas to H₂O dew points no higher than −60 °C, i.e. ≤−60 °C. Such a dry gas is preferable, as it may be utilized as a recovery gas for drying the enthalpy wheel 110. As a way of example, the zeolite adsorption bed 230, e.g. a zeolite 13X or zeolite 5A, may prior to an adsorption cycle contain 0.01 moles H₂O per kg zeolite adsorbent. At an adsorption temperature of 0 °C, i.e. that the gas entering the zeolite adsorption bed 230 holds 0 °C as it enters the zeolite adsorption bed 230, the zeolite adsorption bed 230 will be capable of adsorbing approximately 5 to 10 moles H₂O/kg before gas with a dew-point higher than −60 °C is detected at the zeolite adsorption bed outlet. Higher than −60 °C may here be considered as for example −50 °C, −40 °C etc. It will be appreciated by a person skilled in the art that any number of zeolite adsorption beds may be employed.

The zeolite adsorption bed may generally according to the present disclosure comprise zeolite 13X and/or zeolite 5A as an adsorbent. The adsorbent may for example be present in the form of a packed bed of adsorbent beads, or alternatively be coated on a porous material or matrix. A person skilled in the art will appreciate that the exact shape and structure of a zeolite adsorption bed may vary, for example based on application. As a way of example, the zeolite adsorption bed may comprise zeolite type 13X and be configured to adsorb 200 g±25 g moisture per kg adsorbent, assuming incoming gas with a dew point of −35 °C±2 °C and temperature of 0 °C±1 °C.

The zeolite adsorption bed may, as will be appreciated by a person skilled in the art, be recovered using a wide range of techniques. Generally, the zeolite adsorption bed may be connected to a separate recovery system where CO₂ adsorbed in the zeolite adsorption bed is released and captured, for example by heating the zeolite adsorption bed.

As schematically illustrated in FIG. 1, the zeolite adsorption bed 230 is further connected to the first heat exchanger 160. The zeolite adsorption bed 230 may here be connected to the first heat exchanger second conduit 180 such that the gas may further flow from the zeolite adsorption bed 230 into and through the first heat exchanger second conduit 180. As the gas from the zeolite adsorption bed 230 entering the first heat exchanger second conduit 180 is colder than then gas entering the first heat exchanger first conduit 170, heat from the gas in the first heat exchanger first conduit 170 may then be transferred to the gas in the first heat exchanger second conduit 180. As a result, the gas in the first heat exchanger first conduit 170 may be cooled.

As schematically illustrated in FIG. 1, the first heat exchanger 160 is upstream, i.e. away from the zeolite adsorption bed 230 against the flow direction, connected to the enthalpy wheel 110. The first heat exchanger second conduit 180 may here be connected to the enthalpy wheel extract section 150 such that the gas may further flow from the first heat exchanger second conduit 180 into and through the enthalpy wheel extract section 150. Upon entering the enthalpy wheel extract section 150, the gas is very dry and thus suitable for recovering the moisture adsorbed by the storage mass 120 of the enthalpy wheel 110 as the gas entered through the enthalpy wheel supply section 140. The gas is, upon entering the enthalpy wheel extract section 150, warmer than it was upon leaving the zeolite adsorption bed 230, as the gas has obtained some heat from having been conducted through the first heat exchanger second conduit 180.

The system 100 may according to an embodiment of the disclosure, further comprise a third heat exchanger 250. As schematically illustrated in FIG. 2, the third heat exchanger 250 may be connected between the first heat exchanger 160 and the enthalpy wheel 110 downstream, i.e. in the direction away from along the flow direction, from the zeolite adsorption bed 230. The third heat exchanger 250 may here be employed in order to transfer heat generated by the chiller 190, e.g. the heat generated from the heat pump 195 of the chiller 190, to the gas prior to the gas entering the enthalpy wheel 110, i.e. the extract segment 150 of the enthalpy wheel 110. The third heat exchanger 250 may comprise a third heat exchanger first conduit 260 and a third heat exchanger second conduit 270, where the third heat exchanger second conduit 270 may be connected in series with and between the first heat exchanger second conduit 180 and the extract segment 150 of the enthalpy wheel 110. The chiller 190 may thus be configured to dissipate heat via the third heat exchanger first conduit 260 and said heat may thus be transferred to the gas as the gas passes through the third heat exchanger second conduit 270.

The enthalpy wheel 110 is according to the present disclosure configured to operate as a heat exchanger wheel, meaning that the enthalpy wheel 110 is configured to absorb heat from a gas moving through its supply segment 140 and to give of at least part of said heat to a gas flowing through its extract segment 150. The enthalpy wheel 110 may according to the present disclosure have a temperature efficiency, η_{T}, of at least 70%, preferably at least 90%, even more preferably at least 95%. The temperature efficiency may here be defined as the efficiency of the enthalpy wheel 110 to transfer sensible heat during a counter flow operation, as schematically visualized in FIG. 6. During a counterflow operation, a supply gas with constant temperature flows through the supply segment 140 of the enthalpy wheel 110, e.g. into an internal reservoir, while gas, e.g. from the internal reservoir, simultaneously flows out to the supply side of the enthalpy wheel 110 through the extract segment 150 of the enthalpy wheel 110. The temperature efficiency, η_{T}, of an enthalpy wheel 110, e.g. when used as a heat transfer device, may here be defined as η_{T}=(T_{s,out}−T_{s,in})/(T_{e,in}−T_{s,in}). Here, T_{s,in} is the temperature of the gas entering the supply segment 140, T_{s,out} is the temperature of the gas exiting the supply segment 140, T_{e,in} is the temperature of the gas entering the extract segment 150, e.g. from the internal reservoir, and T_{e,out} is the temperature of the gas exiting the extract segment 150. Gas may enter the supply segment 140 through a supply segment inlet 151 and exit the supply segment 140 through a supply segment outlet 152. Gas may enter the extract segment 150 through an extract segment inlet 153 and exit the extract segment 150 through an extract segment outlet 154.

The enthalpy wheel 110 is according to the present disclosure further configured to perform humidity recovery, meaning that the enthalpy wheel 110 is configured to adsorb humidity from a gas moving through its supply segment 140 and to give of at least part of said moisture to a gas flowing through its extract segment 150. The enthalpy wheel 110 may according to the present disclosure have a humidity efficiency, ηₓ, of at least 70%. The enthalpy wheel 110 may according to a particular embodiment have a humidity efficiency, ηₓ, of at least 90%, more preferably at least 97%. The humidity efficiency may here be defined as the efficiency of the enthalpy wheel 110 to transfer humidity during a counter flow operation, as schematically visualized in FIG. 6. During a counterflow operation, a supply gas with constant humidity flows through the supply segment 140 of the enthalpy wheel 110, e.g. into an internal reservoir, while gas, e.g. from the internal reservoir, simultaneously flows out to the supply side of the enthalpy wheel 110 through the extract segment 150 of the enthalpy wheel 110. The humidity efficiency, ηₓ, of an enthalpy wheel 110 may here be given as ηₓ=(x_{s,out}−x_{s,in})/(x_{e,in}−x_{s,in}). Here, x_{s,in} is the absolute humidity, e.g. g/kg, of the gas entering the supply segment 140, x_{s,out} is the absolute humidity of the gas exiting the supply segment 140, x_{e,in} is the absolute humidity of the gas entering the extract segment 150, i.e. from the internal reservoir, and x_{e,out} is the absolute humidity of the gas exiting the extract segment 150. Gas may enter the supply segment 140 through a supply segment inlet 151 and exit the supply segment 140 through a supply segment outlet 152. Gas may enter the extract segment 150 through an extract segment inlet 153 and exit the extract segment 150 through an extract segment outlet 154.

As it is desirable to adsorb as much CO₂ as possible, the enthalpy wheel may according to the present disclosure ideally adsorb as little CO₂ and as much H₂O as possible. The H₂O adsorbent of the enthalpy wheel may thus be chosen to preferably adsorb H₂O over CO₂. According to a particular embodiment of the present disclosure, the H₂O adsorbent is 3A molecular sieve, such as for example a zeolite 3A. A 3A molecular sieve such as a zeolite 3A has pores that are too small to adsorb CO₂, but large enough to adsorb H₂O. Alternatively, silica gel may be used as an H₂O adsorbent due to its low affinity for CO₂.

Since water may occupy sites within the zeolite pores of the zeolite adsorption bed and thus block CO₂ uptake, it is preferable that the air entering the zeolite adsorption bed is as dry as possible. The humidity, here defined as the H₂O dew point, which indicates the number of grams of H₂O per kg of gas of the gas exiting the enthalpy wheel, may thus according to the present disclosure be no higher than −25 °C. A dewpoint of −25 °C to −35 °C has been found to be a suitable trade-off with regards to cost and effect, as the operation costs involved with drying the air to dew points lower than −35 °C is considered to outweigh the economic gain of getting an increased adsorption in the zeolite adsorption bed. The dewpoint of the gas exiting the enthalpy wheel downstream, i.e. the gas exiting the enthalpy wheel supply segment is according to an embodiment of the present disclosure at least −35 °C. ηₓ may thus be at least 97%, preferably at least 95%

As will be appreciated by a person skilled in the art, an enthalpy wheel 110 with a η_{T} and ηₓ as described above may be realized at least in number of ways. The enthalpy wheel 110 may as schematically illustrated in FIGS. 5a, 5b and 5c comprise a rotatable storage mass 120 coated with an adsorption material, also referred to as an H₂O adsorbent 130. In a particular embodiment of the disclosure, the storage mass may 120 comprise a corrugated foil or alternatively a complete surface foil. The corrugated foil or complete surface foil may here comprise aluminium, e.g. comprise more than 90% aluminium. Foils may for example be wound on top of each other to form a storage mass 120 in the form of a wheel of sinusoidal channels. It will be appreciated by a person skilled in the art that the size and shape of the enthalpy wheel 110 will depend on the gas flows employed, and that the amount of heat absorption material and H₂O adsorbent 130 will depend on the temperature, humidity and air flow volume of the incoming gas. It will further be appreciated that specific values for η_{T} and ηₓ may be achieved by either making the enthalpy wheel 110 larger or alternatively by mounting multiple enthalpy wheels 110 in a series. It should consequently be understood that an enthalpy wheel 110 may herein generally be interpreted as at least one an enthalpy wheel 110, or a plurality of enthalpy wheels 110 e.g. 2, 3, 4 or 5 enthalpy wheels 110 connected in series and/or parallel. As will be appreciated by a person skilled in the art with knowledge of the present disclosure, the employment of one large enthalpy wheel 110 may be considered equivalent to using several enthalpy wheels 110 in series and/or parallel. Any reference to an enthalpy supply section 140 and/or enthalpy extract section 150 may generally thus refer to any number of enthalpy supply sections 140 and/or enthalpy extract sections 150 connected in a series. FIG. 4 schematically illustrates a system 100 according to the present disclosure comprising a plurality of enthalpy wheels 110 connected in a series.

The pressure difference between the gas entering and exiting the enthalpy wheel may according to the present disclosure be in the range 30-100 Pa. Said range differs from typical values for enthalpy wheels in other operations, which typically may be above 100 Pa. A pressure drop in the range 30-100 Pa may be preferable in order to reduce the power usage involved with driving the gas through the system. Preferably, the pressure drop across the enthalpy wheel is in the range 40-80 Pa, even more preferably in the range 45-55 Pa. In a particular embodiment of the present disclosure, the pressure difference between the enthalpy wheel supply segment and the enthalpy wheel extract segment is at least 400 Pa.

The velocity of the gas conducted through the enthalpy wheel is according to an embodiment of the present disclosure in the range 1-2 m/s, most desired 1 m/s±0.25 m/s. Said velocity has been found to be preferred for optimizing the H₂O adsorption and heat absorption effects of the enthalpy wheel.

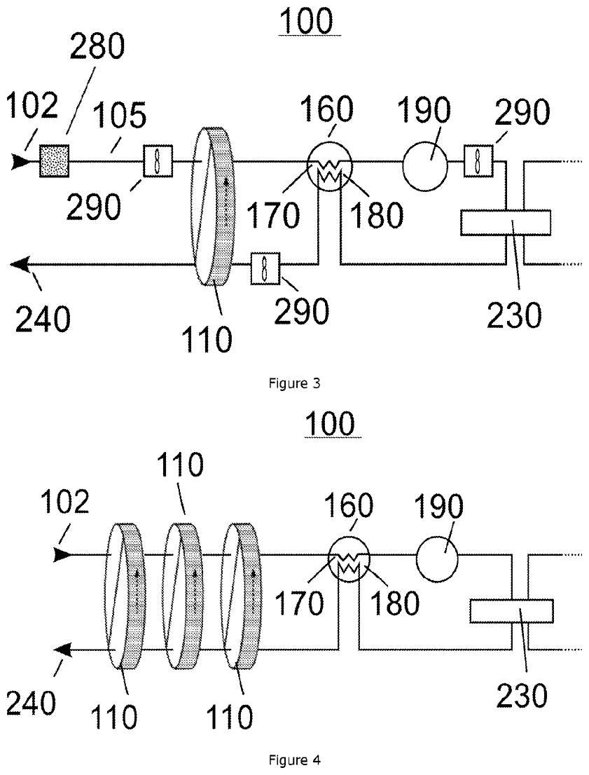

In order to avoid the system clogging up from dust and other particles, the system 100 may further comprise a filter 280, for example arranged downstream from the gas inlet 102 prior to the enthalpy wheel 110. FIG. 3 schematically illustrates a system 100 according to the present disclosure, where a filter 280 is arranged between the gas inlet 102 and the supply segment 140 of the enthalpy wheel 110. The filter 280 may preferably be configured to remove from the gas at least 50% of all solid particulates with a diameter exceeding 1 micron. Even more preferably, the filter 280 may be configured to remove from the gas at least 90% of all solid particulates with a diameter exceeding 1 micron.

In order to maintain a gas flow through the system 100, the system 100 may comprise one or more fans 290. FIG. 3 schematically illustrates an embodiment of the disclosure where the system 100 comprises one or more fans 290. A fan 290 may for example be positioned between the chiller 190 and the zeolite adsorption bed 230. Alternatively or additionally a fan 290 may be positioned between the first heat exchanger second conduit 180 and the extract segment 150 of the enthalpy wheel 110. Alternatively or additionally a fan 290 may be positioned between the gas inlet 102 and the supply segment 140 of the enthalpy wheel 110. Any fan 280 may here be configured to drive the gas through the system 100.

1. A method for removing CO₂ from a gas, the method comprising the steps of:
a) conducting the gas through an enthalpy wheel comprising a storage mass coated with an H₂O adsorbent, thereby adsorbing moisture and absorbing heat from the gas, a temperature efficiency of the enthalpy wheel being at least 70%;
b) cooling the gas from the enthalpy wheel by a first heat exchanger;
c) additionally cooling the gas from the first heat exchanger by a chiller;
d) adsorbing CO₂ from the gas from the chiller by a zeolite adsorption bed;
e) heating the gas from the zeolite adsorption bed in the first heat exchanger, thereby providing the cooling in step b); and
f) conducting the gas from the first heat exchanger through the enthalpy wheel, thereby releasing from the enthalpy wheel the adsorbed moisture and absorbed heat.

2. The method according to claim 1, further comprising additionally heating the gas from the first heat exchanger using heat generated by the chiller between step e) and step f).

3. The method according to claim 1, wherein the pressure difference between the gas entering and exiting the enthalpy wheel in step a) is in the range 30-100 Pa.

4. The method according to claim 1, wherein a velocity of the gas conducted through the enthalpy wheel in step a) is in the range 1-2 m/s.

5. The method according to claim 1, wherein a dew point of the gas exiting the enthalpy wheel in step a) is no higher than −25 °C.

6. The method according to claim 1, wherein a dew point of the gas exiting the enthalpy wheel in step a) is at least −35 °C.

7. The method according to claim 1, wherein a temperature difference between the gas entering and exiting the heat exchanger in step c) is in the range 2-15 °C.

8. The method according to claim 1, wherein a temperature difference between the gas entering and exiting the chiller in step d) is in the range 1-4 °C.

9. The method according to claim 1, wherein a dew point of the gas exiting the zeolite adsorption bed in step d) is no higher than −60 °C.

10. The method according to claim 1, further comprising removing at least 50% of all solid particulates with a diameter exceeding 1 micron prior to step a).

11. A system for removing carbon dioxide (CO₂) from a gas, the system comprising:
a gas inlet configured to receive the gas;
an enthalpy wheel comprising
a supply segment,
an extract segment, and
a storage mass coated with an H₂O adsorbent,
a temperature efficiency of the enthalpy wheel being at least 70%;
a first heat exchanger comprising
a first heat exchanger first conduit, and
a first heat exchanger second conduit;
a chiller comprising
a second heat exchanger comprising
a second heat exchanger first conduit, and
a second heat exchanger second conduit the chiller being configured to circulate cooling fluid through the second heat exchanger second conduit;
a zeolite absorption bed; and
a gas outlet,
wherein the gas inlet is in fluid communication with the zeolite adsorption bed via first the supply segment of the enthalpy wheel, followed by the first heat exchanger first conduit and then the second heat exchanger first conduit, and
wherein the zeolite adsorption bed is in fluid communication with the gas outlet via the first heat exchanger second conduit, followed by the extract segment of the enthalpy wheel.

12. The system according to claim 11, further comprising a filter disposed between the gas inlet and the supply segment of the enthalpy wheel, the filter being configured to remove at least 50% of all solid particulates with a diameter exceeding 1 micron from the gas.

13. The system according to claim 11, further comprising a third heat exchanger comprising
a third heat exchanger first conduit, and
a third heat exchanger second conduit,
wherein the chiller is configured to dissipate heat via the third heat exchanger first conduit, and
wherein the third heat exchanger second conduit is connected in series with and between the first heat exchanger second conduit and the extract segment of the enthalpy wheel.

14. The system according to claim 11, further comprising at least one fan disposed between one or more of: (i) the chiller and the zeolite adsorption bed, and (ii) the first heat exchanger second conduit (180) and the extract segment (150) of the enthalpy wheel.

15. The system according to claim 11, wherein the storage mass is an aluminum mesh.

16. The method according to claim 3, wherein the pressure difference is in the range 40-80 Pa.

17. The method according to claim 3, wherein the pressure difference is in the range 45-55 Pa.

18. The system according to claim 11, wherein the H₂O adsorbent is a 3a molecular sieve or silica gel.

19. The system according to claim 14, wherein the H₂O adsorbent is a 3a molecular sieve or silica gel.
